(19) United States
(12) Patent Application Publication
(10) Pub. No.: US 2005/0285631 A1
(43) Pub. Date: Dec. 29, 2005

(54) Data latch pre-equalization

(75) Inventors: Matthew Goldman, Folsom, CA (US); Saad P. Monasa, Sacramento, CA (US); Kerry D. Tedrow, Folsom, CA (US)

Correspondence Address: LeMoine Patent Services, PLLC;c/o PortfolioIP, P.O. Box 52050, Minneapolis, MN, 55402, US

(73) Assignee: Intel Corporation

(21) Appl. No.: 10/878,809

(22) Filed: Jun. 28, 2004

(51) Int. Cl. G01N 30/86

(52) U.S. Cl. 327/1

(57) ABSTRACT

A latch includes a switch to equalize voltages of two complementary nodes. The latch also includes at least one transistor to decouple the latch from a power supply node.

### FIELD

The present invention relates generally to electronic circuits, and more specifically to latch circuits that latch digital data.

### BACKGROUND

Data latches may be used to sense small voltage differences that represent stored data. Some data latches sense the small voltage differences and then produce large voltage differences on one or more circuit nodes to “latch” the data. When performing multiple data latching operations in sequence, it may take time for the large voltage differences to change, which in turn may slow the operation of the latch.

### BRIEF DESCRIPTION OF THE DRAWINGS

FIG. 1 shows a diagram of a latch and a data source;

FIG. 2 shows a flowchart in accordance with various embodiments of the present invention;

FIGS. 3 and 4 show diagrams of memory devices; and

FIG. 5 shows a system diagram in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

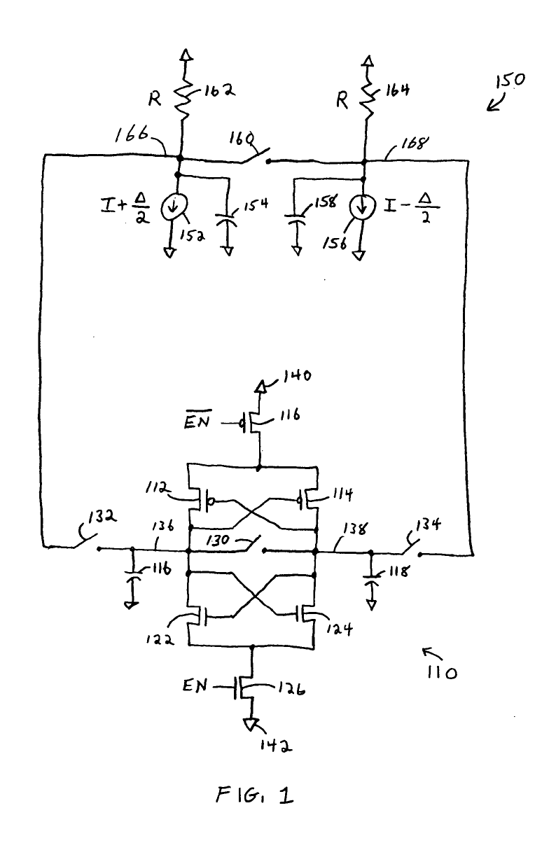

FIG. 1 shows a diagram of a latch and a data source. Latch 110 includes transistors 112, 114, 116, 122, 124, and 126. Latch 110 also includes switch 130. Transistors 112 and 114 have source terminals coupled together, and have cross-coupled gate nodes and drain nodes. For example, the gate node of transistor 112 is coupled to the drain node of transistor 114, and the gate node of transistor 114 is coupled to the drain node of transistor 112. As used herein, the term “cross-coupled transistors” is used to refer to transistors coupled in the fashion shown by transistors 112 and 114. As shown in FIG. 1, transistors 122 and 124 are also a pair of cross-coupled transistors.

The transistors shown in FIG. 1 are shown as isolated gate transistors, and specifically as metal oxide semiconductor field effect transistors (MOSFETs). Transistors 112, 114, and 116 are shown as P-type MOSFETs, and the remaining transistors are shown as N-type MOSFETs. Other types of switching or amplifying elements may be utilized for the various transistors of latch 110 without departing from the scope of the present invention. For example, the transistors of latch 110 may be junction field effect transistors (JFETs), bipolar junction transistors (BJTs), or any device capable of performing as described herein.

Transistor 116 is coupled in series between upper power supply node 140 and the remainder of latch 110. The source node of transistor 116 is coupled to upper power supply node 140, and the drain node of transistor 116 is coupled to cross-coupled transistors 112 and 114. The gate node of transistor 126 is coupled to receive a signal \overline{EN}. When \overline{EN} is low, transistor 116 is on, and upper power supply node 140 is able to supply current for the operation of latch 110. When \overline{EN} is high, transistor 116 is off, and upper power supply node 140 is not able to supply current for the operation of latch 110. Transistor 116 operates as a switch to conditionally couple or decouple a power supply node from the latch. In some embodiments, a switching element other than a PMOSFET may be utilized to decouple upper power supply node 140 from the remainder of latch 110.

Transistor 126 is coupled in series between lower power supply node 142 and the remainder of latch 110. The source node of transistor 126 is coupled to lower power supply node 142, and the drain node of transistor 126 is coupled to cross-coupled transistors 122 and 124. The gate node of transistor 126 is coupled to receive a signal EN. When EN is high, transistor 126 is on, and lower power supply node 142 is able to supply current for the operation of latch 110. When EN is low, transistor 126 is off, and lower power supply node 142 is not able to supply current for the operation of latch 110. Transistor 126 operates as a switch to conditionally couple or decouple a power supply node from the latch. In some embodiments, a switching element other than an NMOSFET may be utilized to decouple lower power supply node 142 from the remainder of latch 110.

Complementary nodes 136 and 138 serve as both input nodes and output nodes for latch 110. As described further below, latch 110 receives a voltage differential from data source 150 at complementary nodes 136 and 138 when they are serving as input nodes. Latch 110 senses the voltage differential on complementary nodes 136 and 138, and then drives complementary nodes 136 and 138 substantially to the power supply voltages present on power supply nodes 140 and 142. Nodes 136 and 138 are referred to as “complementary” in part because they are driven to complementary voltage values. This operation is described further below.

Switch 130 is coupled between complementary nodes 136 and 138. When switch 130 is closed, the voltage between the pair of complementary nodes approaches the same value, or “equalizes.” In some embodiments, switch 130 is closed when transistors 116 and 126 are off to equalize the two complementary nodes before latch 110 senses data. Switch 130 may be any type of circuit element capable of equalizing the two complementary nodes. For example, switch 130 may be an NMOSFET, a PMOSFET, or a pass gate that includes an NMOSFET and a PMOSFET coupled in parallel. The type of circuit element used for switch 130 is not a limitation of the present invention.

Switches 132 and 134 couple complementary nodes 136 and 138 to data source 150. When switches 132 and 134 are open, voltages on complementary nodes 136 and 138 are not influenced by data source 150. Instead, the operation of the two pairs of cross-coupled transistors may drive the complementary nodes to near the power supply voltages, or the operation of switch 130 may equalize the voltages on the complementary nodes when transistors 116 and 126 are off.

Capacitors 116 and 118 hold charge and influence how fast voltages may change on complementary nodes 136 and 138. In some embodiments, capacitors 116 and 118 are not lumped elements; instead, they represent parasitic capacitances distributed among the various circuit elements coupled to the complementary nodes. For example, capacitor 116 may represent the capacitance of the gate nodes of transistors 114 and 124, and the capacitance of the drain nodes of transistors 112 and 122. Capacitor 116 may also represent any other capacitance that appears on node 136, regardless of the source of the capacitance.

Data source 150 includes current sources 152 and 156, capacitors 154 and 158, and resistors 162 and 164. Current source 152 provides a current equal to I+Δ/2, and current source 154 provides a current equal to I−Δ/2. The difference between the currents provided by current sources 152 and 156 is equal to Δ. As shown in FIG. 1, resistors 162 and 164 both have a resistance value of R. By virtue of the current differences through resistors 162 and 164, node 166 and node 168 have different voltages.

In some embodiments, data source 150 models a data source and as a reference circuit. For example, current source 152 and resistor 162 may model a memory cell, and current source 156 and resistor 164 may model a reference circuit to which the memory cell contents are compared. In these embodiments, the voltage on node 166 depends on the value of stored data, and node 166 is referred to as a data dependent node. Various embodiments of data storage devices are described with reference to later figures.

Switch 160 is coupled between nodes 166 and 168. When switch 160 is closed, the voltages on nodes 166 and 168 approach the same value, or “equalize.” In some embodiments, switch 160 is closed to equalize nodes 166 and 168 before latch 110 senses data. Switch 160 may be any type of circuit element capable of equalizing nodes 166 and 168. For example, switch 160 may be an NMOSFET, a PMOSFET, or a pass gate that includes an NMOSFET and a PMOSFET coupled in parallel. The type of circuit element used for switch 160 is not a limitation of the present invention.

In some embodiments, the differential current Δ, or the differential voltage on nodes 166 and 168 is very small. For example, data source 150 may model a memory storage device in which the voltage on node 166 represents data held in a memory storage device, and the voltage on node 168 represents a reference, and the magnitude of the difference may be very small. In these embodiments, latch 110 is capable of detecting minute differences. In some embodiments, switch 160 is utilized to increase the ability of latch circuit 110 to quickly discriminate small differences by equalizing nodes 166 and 168 prior to latch 110 sensing the data. By starting with both nodes 166 and 168 at the same voltage, the time between closing switches 132 and 134 and enabling latch 110 may be reduced because the time required for complementary nodes 136 and 138 to achieve a minimum required input differential may be reduced.

As previously described, data source 150 represents data to be read as well as a reference to which the data should be compared. A data read cycle starts with switches 132 and 134 closed, switches 160 and 130 open, and latch 110 disabled. Latch 110 is disabled when EN is low to decouple latch 110 from lower power supply node 142, or when \overline{EN} is high to decouple latch 110 from power supply node 140, or both. Once capacitors 116 and 118 have charged to a point where the voltages on nodes 136 and 138 have enough differential so that latch 110 can correctly discriminate between the two, switches 132 and 134 are opened and latch 110 is enabled by bringing EN high and \overline{EN} low. Latch 110 then drives complementary nodes 136 and 138 substantially to the power rails (the voltages present in power supply nodes 140 and 142).

To increase the speed of repeated reads (or the setup time for the first read), as soon as switches 132 and 134 are opened, switch 160 is closed so that the voltages on nodes 166 and 168 can equalize in preparation for the next read. After the data latched by latch 110 is read out of latch 110, latch 110 is disabled and switch 130 is closed to equalize complementary nodes 136 and 138. This may also be referred to as “pre-equalizing” the two complementary nodes. After the two complementary nodes are partially or completely equalized, switch 130 is opened and switches 132 and 134 may be closed with the two complementary nodes causing little or no differential offset to nodes 166 and 168. Further, the common mode offset introduced by closing switches 132 and 134 may be smaller when latch 110 is equalized prior to reconnecting it to data source 150. Given the reduced magnitude of the offset, latch 110 may take less time to sense the data. Latch 110 is then enabled when nodes 136 and 138 have enough voltage differential so that latch 110 can discriminate between the two.

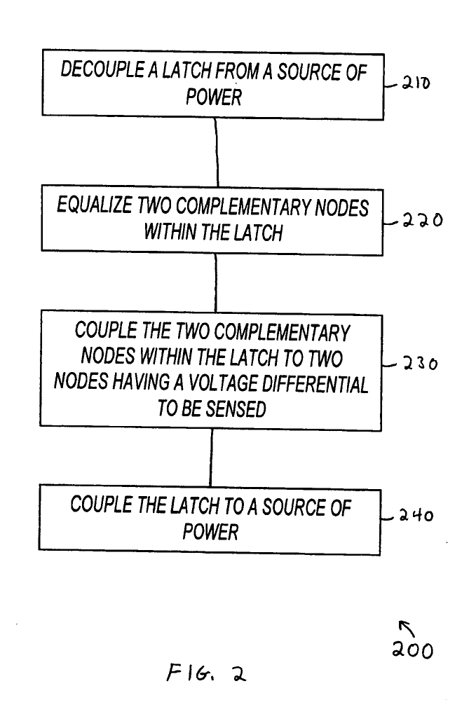

FIG. 2 shows a flowchart in accordance with various embodiments of the present invention. In some embodiments, method 200 may be used to operate a data latch. In some embodiments, method 200, or portions thereof, is performed by a memory device, embodiments of which are shown in the various figures. In other embodiments, method 200 is performed by a control circuit within a memory device. Method 200 is not limited by the particular type of apparatus or software element performing the method. The various actions in method 200 may be performed in the order presented, or may be performed in a different order. Further, in some embodiments, some actions listed in FIG. 2 are omitted from method 200.

Method 200 is shown beginning at block 210 in which a latch is decoupled from a source of power. Block 210 may correspond to turning off one or more transistors coupled in series between a power supply node and a latch. For example, latch 110 (FIG. 1) may be decoupled from a source of power by turning off transistor 116, transistor 126, or both.

At block 220, two complementary nodes within the latch are equalized. This may correspond to closing switch 130 (FIG. 1) for a time period. The time period may be sufficient to force complementary nodes 136 and 138 to the same voltage or to near the same voltage. The time period may be sufficient to have complementary nodes 136 and 138 approach the same voltage, but not significantly change. The act of equalizing may also include opening switch 130 after the time period has expired.

At 230, the two complementary nodes within the latch are coupled to two nodes having a differential voltage to be sensed. This may correspond-to closing switches 132 and 134 (FIG. 1) to couple node 136 to node 166, and to couple node 138 to node 168. After closing switches 132 and 134, any differential voltage or common mode voltage on nodes 136 and 138 may have an impact on the voltages on nodes 166 and 168. This may have an impact on the small voltage differential that exists on nodes 166 and 168. By pre-equalizing the latch (block 220), the voltage differential on the complementary nodes becomes a common mode offset which does not disturb the voltage differential on nodes 166 and 168.

At 240, the latch is coupled to a source of power. This may correspond to transistors 116 and 126 being turned on. When the latch is coupled to a source of power, or “enabled,” the latch senses any voltage differential on the complementary nodes and drives the complementary nodes to near the power rails.

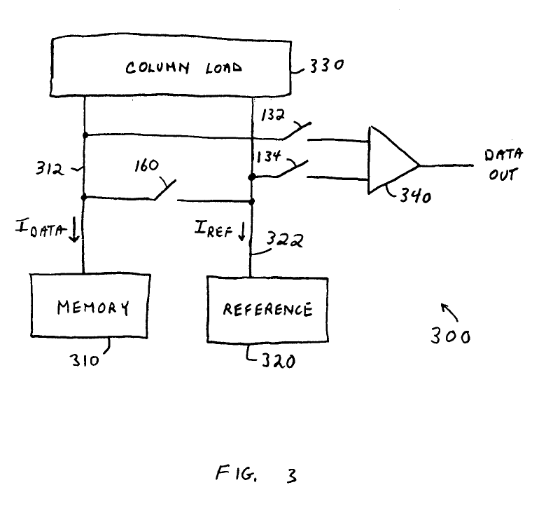

FIG. 3 shows a memory device in accordance with various embodiments of the present invention. Memory device 300 includes memory 310, reference 320, column load 330, and latch 340. Memory device 300 is also shown having switches 160, 132, and 134, which are described above with reference to FIG. 1. Latch 340 may include a latch capable of equalizing two complementary nodes, such as latch 110 (FIG. 1). Latch 340 may also include a latch that can be enabled or disabled by removing the latch from one or more sources of power.

Memory 310 may be any type of memory that provides a current I_{DATA} that varies based on the data held in the memory. For example, memory 310 may be a static random access memory (SRAM), a dynamic random access memory (DRAM), a volatile memory, or a non-volatile memory. In some embodiments, memory 310 includes a floating gate memory such as FLASH memory. Memory 310 may include a single memory cell or multiple memory cells. In some embodiments, memory 310 includes a column of memory cells, and one memory cell is selected for reading at a time. In these embodiments, latch 340 is “shared” among multiple memory cells arranged in a column.

Reference 320 is a reference device that produces a reference current I_{REF}. I_{REF} is compared to I_{DATA} when determining whether memory 310 is storing a “1” or a “0.” In some embodiments, reference 320 includes a current source. The manner in which reference 320 is implemented is not a limitation of the present invention.

Column load 330 produces a voltage on node 312 based on I_{DATA}, and produces a voltage on node 322 based on I_{REF}. Column load 330 may include resistive devices such as resistors 162 and 164 (FIG. 1) or may include active devices such as transistors. In some embodiments, column load 330 is shared among a column of memory cells in memory 310. In these embodiments, a particular memory cell in memory 310 is selected to be read, and column load 330 receives I_{DATA} based on the data in that memory cell.

Memory device 300 may include a control circuit to control the operation of switches 160, 132, and 134, and also to control the operation of latch 340. The control circuit may be synchronous or asynchronous. For example, a control circuit may include a state machine, a processor interface, or the like. The various embodiments of the present invention are not limited by the existence or non-existence of a control circuit. Further, the various embodiments of the present invention are not limited by the type of control circuit implementation.

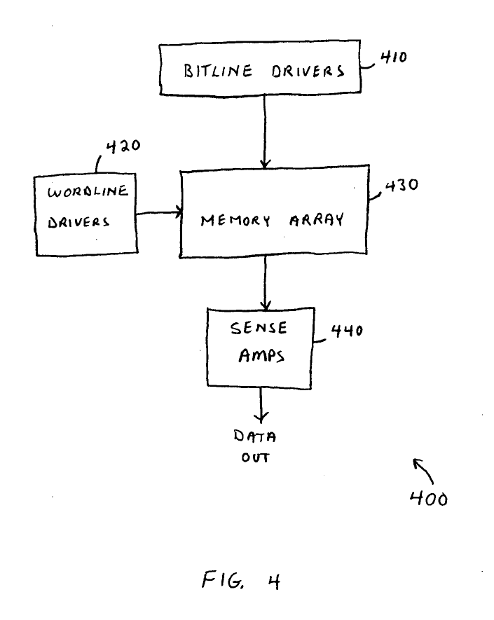

FIG. 4 shows a memory device in accordance with various embodiments of the present invention. Memory device 400 includes bit line drivers 410, word line drivers 420, memory array 430, and sense amplifiers 440. Memory array 430 may be any type of memory array capable of storing data. For example, memory array 430 may be a static random access memory (SRAM), a dynamic random access memory (DRAM), a volatile memory, or a non-volatile memory. In some embodiments, memory array 430 includes rows and columns of memory such as FLASH memory. In these embodiments, word line drivers 420 may select a row of memory cells to be read, and bit line drivers 410 may select which columns include memory cells to be read.

Sense amplifiers 440 may include any number of sense amplifiers, and the sense amplifiers may include any number of latches that may be pre-equalized, such as latch 110 (FIG. 1). For example, sense amplifiers 440 may include one sense amplifier for each column of memory array 430, or sense amplifiers 440 may include fewer sense amplifiers that are shared among various columns in memory array 430. The number of arrangement of sense amplifiers in sense amplifiers 440 is not a limitation of the present invention.

In some embodiments, memory device 400 is part of an integrated circuit. For example, memory device 400 may be a packaged integrated circuit that includes an interface to allow memory device 400 be used as part of an electronic system. Also for example, memory device 400 may be included in a packaged integrated circuit that also includes other components, functional blocks, or subsystems. Further, in some embodiments, memory device 400 may be part of an unpackaged integrated circuit die that is sold as an unpackaged device.

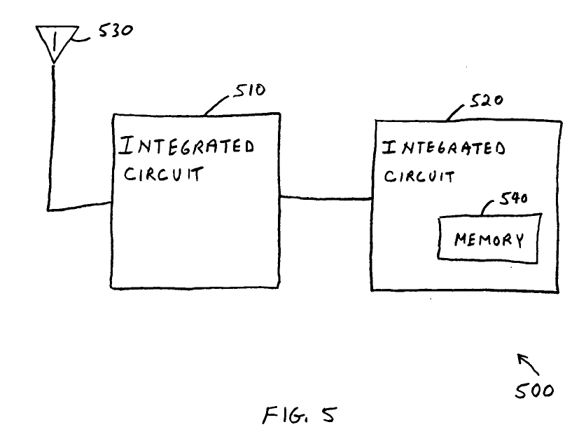

FIG. 5 shows a system diagram in accordance with various embodiments of the present invention. FIG. 5 shows system 500 including integrated circuits 510 and 520, and antenna 530. In operation, system 500 receives a signal using antenna 530, and the signal is processed by the various elements shown in FIG. 5. Antenna 530 may be a directional antenna or an omni-directional antenna. As used herein, the term omni-directional antenna refers to any antenna having a substantially uniform pattern in at least one plane. For example, in some embodiments, antenna 530 may be an omni-directional antenna such as a dipole antenna, or a quarter wave antenna. Also for example, in some embodiments, antenna 530 may be a directional antenna such as a parabolic dish antenna or a Yagi antenna. In some embodiments, antenna 530 may include multiple physical antennas.

Integrated circuit 510 may include a radio frequency (RF) receiver, transmitter, or transceiver coupled to antenna 530. For example, in some embodiments, an RF receiver receives a signal from antenna 530 and performs “front end” processing such as low noise amplification (LNA), filtering, frequency conversion or the like.

Integrated circuit 520 includes memory 540. In some embodiments, memory 540 may include latches that may be removed from one or more power sources and pre-equalized. For example, memory 540 may include one or more latches such as latch 110 (FIG. 1). Also for example, memory 540 may include various embodiments of the present invention to decouple a latch from one or more power sources, and to pre-equalize complementary nodes within the latch.

In some embodiments, integrated circuit 520 may be a processor such as a microprocessor, a digital signal processor, a microcontroller, or the like. In some of these embodiments, memory 540 may be a cache memory on the same integrated circuit die. In other embodiments, memory 540 may be a cache memory co-located with a processor such as in a large package or multi-chip module. Memory 540 is shown used with an antenna in system 500. Many other uses for memory 540 exist. For example, memory 540 may be used in systems without an antenna.

Either integrated circuit 510 or 520 may be a processor or an integrated circuit other than a processor such as a radio frequency (RF) receiver, transmitter, or transceiver, an application-specific integrated circuit (ASIC), a communications device, a memory controller, or a memory such as a dynamic random access memory (DRAM). For ease of illustration, portions of integrated circuits 510 and 520 are not shown. The integrated circuits may include much more circuitry than illustrated in FIG. 5 without departing from the scope of the present invention.

Systems represented by the various foregoing figures can be of any type. Examples of represented systems include computers (e.g., desktops, laptops, handhelds, servers, tablets, web appliances, routers, etc.), wireless communications devices (e.g., cellular phones, cordless phones, pagers, personal digital assistants, wireless network interfaces, etc.), computer-related peripherals (e.g., printers, scanners, monitors, etc.), entertainment devices (e.g., televisions, radios, stereos, tape and compact disc players, video cassette recorders, camcorders, digital cameras, MP3 (Motion Picture Experts Group, Audio Layer 3) players, video games, watches, etc.), and the like.

Latches, switches, transistors, memory arrays, and other embodiments of the present invention can be implemented in many ways. In some embodiments, they are implemented in integrated circuits as part of memory devices. In some embodiments, design descriptions of the various embodiments of the present invention are included in libraries that enable designers to include them in custom or semi-custom designs. For example, any of the disclosed embodiments can be implemented in a synthesizable hardware design language, such as VHDL or Verilog, and distributed to designers for inclusion in standard cell designs, gate arrays, or the like. Likewise, any embodiment of the present invention can also be represented as a hard macro targeted to a specific manufacturing process.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

1. A method of latching data comprising:
decoupling a latch from a source of power;
equalizing two complementary nodes within the latch;
coupling the two complementary nodes within the latch to two nodes having a voltage differential to be sensed; and
coupling the latch to the source of power.

2. The method of claim 1 wherein decoupling comprises turning off a transistor in series between the latch and an upper power supply node.

3. The method of claim 1 wherein decoupling comprises turning off a transistor in series between the latch and a lower power supply node.

4. The method of claim 1 wherein decoupling comprises turning off a first transistor between the latch and an upper power supply node and turning off a second transistor between the latch and a lower power supply node.

5. The method of claim 1 wherein equalizing two complementary nodes between the latch comprises closing a switch between the two complementary nodes.

6. The method of claim 5 wherein equalizing further comprises opening the switch between the two complementary nodes.

7. The method of claim 6 wherein coupling the two complementary nodes within the latch to two nodes having a voltage differential to be sensed comprises coupling a first of the two complementary nodes to receive a voltage that is dependent on a value stored in a memory cell, and coupling a second of the two complementary nodes to receive a reference voltage.

8. A latch circuit comprising:
a first pair of cross-coupled transistors;
a second pair of cross-coupled transistors coupled to the first pair of cross-coupled transistors at two complementary nodes;
a first transistor coupled in series between the first pair of cross-coupled transistors and an upper power supply node;
a second transistor coupled in series between the second pair of cross-coupled transistors and a lower power supply node; and
a switch to equalize voltages at the two complementary nodes.

9. The latch circuit of claim 8 wherein the first cross-coupled pair of transistors comprises P-type isolated gate transistors.

10. The latch circuit of claim 9 wherein the second cross-coupled pair of transistors comprises N-type isolated gate transistors.

11. The latch circuit of claim 8 further comprising a first switch to couple a data dependent node to a first of the two complementary nodes.

12. The latch circuit of claim 11 further comprising a second switch to couple a reference node to a second of the two complementary nodes.

13. An apparatus including a memory storage device and a latch to sense data stored in the memory storage device, the latch comprising:
two complementary nodes coupled within the latch as input nodes and output nodes;
at least one transistor to decouple the latch from a power supply node; and
a switch to equalize a voltage between the two complementary nodes.

14. The apparatus of claim 13 wherein the memory storage device comprises an array of memory cells.

15. The apparatus of claim 14 wherein the array of memory cells comprises floating gate memory.

16. The apparatus of claim 13 wherein the at least one transistor to decouple the latch from the power supply node comprises a transistor coupled between the latch and an upper power supply node.

17. The apparatus of claim 16 further comprising a second transistor coupled between the latch and a lower power supply node.

18. The apparatus of claim 13 further comprising a second switch coupled between the memory storage device and a first of the two complementary nodes.

19. The apparatus of claim 18 further comprising a third switch coupled between a reference node and a second of the two complementary nodes.

20. An electronic system comprising:
an antenna; and
an integrated circuit coupled to the antenna, the integrated circuit including a memory device, the memory device comprising a plurality of latches, wherein at least one of the plurality of latches includes at least one switch to disconnect a power source, and the at least one of the plurality of latches includes a switch to conditionally couple two complementary nodes.

21. The electronic system of claim 20 wherein the at least one of the plurality of latches comprises:
a first pair of cross-coupled transistors; and
a second pair of cross-coupled transistors coupled to the first pair of cross-coupled transistors at the two complementary nodes.

22. The electronic system of claim 20 wherein the memory device further comprises floating gate memory cells.
